(19) United States
(12) Patent Application Publication
(10) Pub. No.: US 2025/0337463 A1
(43) Pub. Date: Oct. 30, 2025

(54) WIRELESS LINKS FOR DATA CENTER TRAFFIC

(71) Applicant: QUALCOMM Incorporated, San Diego, CA (US)

(72) Inventors: Gideon Shlomo KUTZ, Ramat Hasharon (IL); Assaf TOUBOUL, Netanya (IL); Idan Michael HORN, Hod Hasharon (IL); Reuven ALPERT, Givat Ada (IL); Alex MIKUNIS, Netanya (IL); Yehonatan DALLAL, Kfar Saba (IL)

(21) Appl. No.: 19/090,838

(22) Filed: Mar. 26, 2025

Related U.S. Application Data
(60) Provisional application No. 63/639,803, filed on Apr. 29, 2024.

(51) Int. Cl. H04B 7/06; H04L 43/0882; H04W 40/12

(52) U.S. Cl. CPC H04B 7/0617; H04L 43/0882; H04W 40/12

(57) ABSTRACT

Methods, systems, and devices for wireless communications are described. Data centers may be used for a variety of applications and may include hundreds or thousands of server racks and wired connections between the server racks organized in a hierarchical structure. Server racks may be connected to a leaf switch node, which may be connected to other leaf switch nodes via spine and/or core switch nodes. Wireless communications between switch nodes may be implemented in a data center in addition to wired connections. As the switch nodes are stationary, beam training for communication between the switch nodes may be performed infrequently. A first switch node may use a wireless link to communicate with another switch node (e.g., in addition to or instead of the wired link path) based on a traffic condition. Wireless links may be dynamically reconfigurable. Wireless links may be used to broadcast a communication to multiple switch nodes.

### CROSS REFERENCES

The present Application for Patent claims benefit of U.S. Provisional Patent Application No. 63/639,803 by KUTZ et al., entitled “WIRELESS LINKS FOR DATA CENTER TRAFFIC,” filed Apr. 29, 2024, assigned to the assignee hereof, and expressly incorporated herein.

### FIELD OF TECHNOLOGY

The following relates to wireless communications, including wireless links for data center traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Data centers may be used for a variety of applications such as hosting services (e.g., cloud storage or websites), responding to web queries (e.g., search engines), or social media. Data centers may demand high throughput and low latency. Data centers may include hundreds of server racks and may rely on wired connections between the server racks (e.g., wired optical links). Full mesh networks for data centers may be impractical as connecting N server racks in a full mesh network involves N² wired links, which would involve tens of thousands or hundreds of thousands of wired links when N>100. Accordingly, data centers may use a hierarchical structure with two or three levels (e.g., a leaf-spine-core topology) to create a wired path between each server rack with a reduced quantity of wired links. For example, multiple server racks may be connected to a leaf switch node, which may be connected to other leaf switch nodes via spine switch nodes and/or core switch nodes. A switch node may also be referred to as a network switch node. In such wired data center networks, each wired link connects two switch nodes. Accordingly, the wired hierarchical structure may involve multiple hops between a source switch node and a target switch node.

### SUMMARY

The systems, methods, and devices of this disclosure each have several innovative aspects, no single one of which is solely responsible for the desirable attributes disclosed herein.

A method for wireless communications by a first network switch node of a data center is described. The method may include performing wireless beam training with one or more other network switch nodes of the data center, where the first network switch node is connected via one or more respective wired link paths to the one or more other network switch nodes and transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

A first network switch node of a data center is described. The first network switch node of a data center may include one or more memories storing processor executable code, and one or more processors coupled with the one or more memories. The one or more processors may individually or collectively be operable to execute the code to cause the first network switch node of a data center to perform wireless beam training with one or more other network switch nodes of the data center, where the first network switch node is connected via one or more respective wired link paths to the one or more other network switch nodes and transmit a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

Another first network switch node of a data center is described. The first network switch node of a data center may include means for performing wireless beam training with one or more other network switch nodes of the data center, where the first network switch node is connected via one or more respective wired link paths to the one or more other network switch nodes and means for transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

A non-transitory computer-readable medium storing code for wireless communications by a first network switch node of a data center is described. The code may include instructions executable by one or more processors to perform wireless beam training with one or more other network switch nodes of the data center, where the first network switch node is connected via one or more respective wired link paths to the one or more other network switch nodes and transmit a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

In some examples of the method, first network switch node, and non-transitory computer-readable medium described herein, the traffic condition includes a traffic volume exceeding a threshold associated with a wired link path between the first network switch node and the second network switch node and the wired link path may be one of the one or more respective wired link paths.

Some examples of the method, first network switch node, and non-transitory computer-readable medium described herein may further include operations, features, means, or instructions for transmitting a second data communication to the second network switch node via the wired link path, where the second data communication at least partially overlaps in time with the data communication.

In some examples of the method, first network switch node, and non-transitory computer-readable medium described herein, the wired link path includes a set of multiple wired links and the traffic volume exceeding the threshold associated with the wired link path includes the traffic volume exceeding the threshold for any wired link of the set of multiple wired links.

In some examples of the method, first network switch node, and non-transitory computer-readable medium described herein, the traffic condition includes a latency requirement associated with the data communication.

Some examples of the method, first network switch node, and non-transitory computer-readable medium described herein may further include operations, features, means, or instructions for determining that a quantity of wired links in a wired link path between the first network switch node and the second network switch node exceeds a threshold quantity associated with the latency requirement, where the traffic condition includes the quantity of wired links exceeding the threshold quantity, and where the wired link path may be one of the one or more respective wired link paths.

In some examples of the method, first network switch node, and non-transitory computer-readable medium described herein, the traffic condition includes a type of data associated with the data communication and the second network switch node may be associated with the type of data.

In some examples of the method, first network switch node, and non-transitory computer-readable medium described herein, transmitting the data communication may include operations, features, means, or instructions for transmitting the data communication to a third network switch node via the wireless beam, where the one or more other network switch nodes include the third network switch node, and where the traffic condition includes transmission of the data communication to the second network switch node and the third network switch node.

Some examples of the method, first network switch node, and non-transitory computer-readable medium described herein may further include operations, features, means, or instructions for transmitting the data communication to a third network switch node via second wireless beam, where the one or more other network switch nodes include the third network switch node, where transmission of the data communication to the third network switch node at least partially overlaps in time with transmission of the data communication to the second network switch node, and where the traffic condition includes transmission of the data communication to the second network switch node and the third network switch node.

In some examples of the method, first network switch node, and non-transitory computer-readable medium described herein, transmitting the data communication may include operations, features, means, or instructions for transmitting the data communication to the second network switch node via an assistive node, where the wireless beam may be in a direction of the assistive node from a perspective of the first network switch node, and where the wireless beam training indicates for the first network switch node to use the assistive node for wireless communication with the second network switch node.

Some examples of the method, first network switch node, and non-transitory computer-readable medium described herein may further include operations, features, means, or instructions for transmitting, to the assistive node, an indication that a destination of the data communication may be the second network switch node.

In some examples of the method, first network switch node, and non-transitory computer-readable medium described herein, transmitting the data communication may include operations, features, means, or instructions for transmitting the data communication via one or both of a first bandwidth within a sub-terahertz frequency band or a second bandwidth of a 60 gigahertz frequency band.

Some examples of the method, first network switch node, and non-transitory computer-readable medium described herein may further include operations, features, means, or instructions for receiving, from the second network switch node, a second data communication via the wireless beam or a second wireless beam, where the wireless beam or the second wireless beam may be based on the wireless beam training, and where the second data communication at least partially overlaps in time with the data communication.

Some examples of the method, first network switch node, and non-transitory computer-readable medium described herein may further include operations, features, means, or instructions for receiving, from third network switch node, a second data communication via a second wireless beam, where the second wireless beam may be based on the wireless beam training, where the one or more other network switch nodes include the third network switch node, and where the second data communication at least partially overlaps in time with the data communication.

Some examples of the method, first network switch node, and non-transitory computer-readable medium described herein may further include operations, features, means, or instructions for receiving data associated with the data communication from a server via a wired connection between the server and the first network switch node, where the first network switch node may be connected to a set of servers via a set of corresponding wired connections, the set of servers including the server, and where transmission of the data communication may be based on reception of the data.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports wireless links for data center traffic in accordance with one or more aspects of the present disclosure.

FIG. 2 shows an example of a data center communications system that supports wireless links for data center traffic in accordance with one or more aspects of the present disclosure.

FIG. 3 shows an example of a data center communications system that supports wireless links for data center traffic in accordance with one or more aspects of the present disclosure.

FIG. 4 shows an example of a data center communications system that supports wireless links for data center traffic in accordance with one or more aspects of the present disclosure.

FIG. 5 shows an example of a process flow that supports wireless links for data center traffic in accordance with one or more aspects of the present disclosure.

FIGS. 6 and 7 show diagrams of devices that support wireless links for data center traffic in accordance with one or more aspects of the present disclosure.

FIG. 8 shows a diagram of a communications manager that supports wireless links for data center traffic in accordance with one or more aspects of the present disclosure.

FIG. 9 shows a diagram of a system including a device that supports wireless links for data center traffic in accordance with one or more aspects of the present disclosure.

FIGS. 10 through 12 show flowcharts illustrating methods that support wireless links for data center traffic in accordance with one or more aspects of the present disclosure.

### DETAILED DESCRIPTION

Wireless communications between switch nodes may be implemented in a data center, for example, in addition to the wired link paths. As switch nodes within a data center may be stationary, beam training for wireless communication between the switch nodes may be performed infrequently (e.g., at a low periodicity or when new switch nodes are added to the data center). Wireless communications in data centers may use sub-terahertz (THz) or 60 gigahertz (GHz) frequency bands, which may allow for high bandwidth and therefore large throughput approaching the data rate supported by optical wired connections. Sub-THz and 60 GHz communications allow for narrow beams, which allow for high spectrum spatial reuse (e.g., based on minimal interference between wireless communication between the different switch nodes).

A first switch node may use a wireless link to communicate with another switch node (e.g., in addition to or instead of the wired link path) based on a traffic condition at the first switch node. For example, if the traffic volume for the wired link path exceeds a threshold, the first switch node may communicate data to a second switch node via the wireless link. In wired data center networks, each wired link connects two switch nodes. Thus, absent wireless links, wired link capacities may be over-provisioned in order to support peak throughput, which may lead to low average utilization (e.g., as low as 30%) of data center wired communication resources. The addition of wireless communications capabilities to a wired data center may allow for wired links to be dimensioned for average throughput, and wireless links may be used to supplement the wired links when traffic volume exceeds the average throughput. As another example, wireless links may be used to broadcast a data communication to multiple switch nodes, thereby decreasing the load on wired links when a message is transmitted to multiple switch nodes. The hierarchical structure of a wired data center may involve multiple hops between a source switch node and a target switch node, thereby increasing latency and/or involving multiple intermediary switch nodes in communications and thus burdening the communication system. A wireless link between switch nodes may be used for low latency communications to avoid the latency involved with multiple hops via a wired link path between switch nodes. In some examples, a data center may include assistive nodes such as repeaters or reflectors to enable switch nodes throughout the data center to communicate with each other via wireless links.

Aspects of the disclosure are initially described in the context of wireless communications systems. Aspects of the disclosure are further illustrated by and described with reference to data center communications system, process flows, apparatus diagrams, system diagrams, and flowcharts that relate to wireless links for data center traffic.

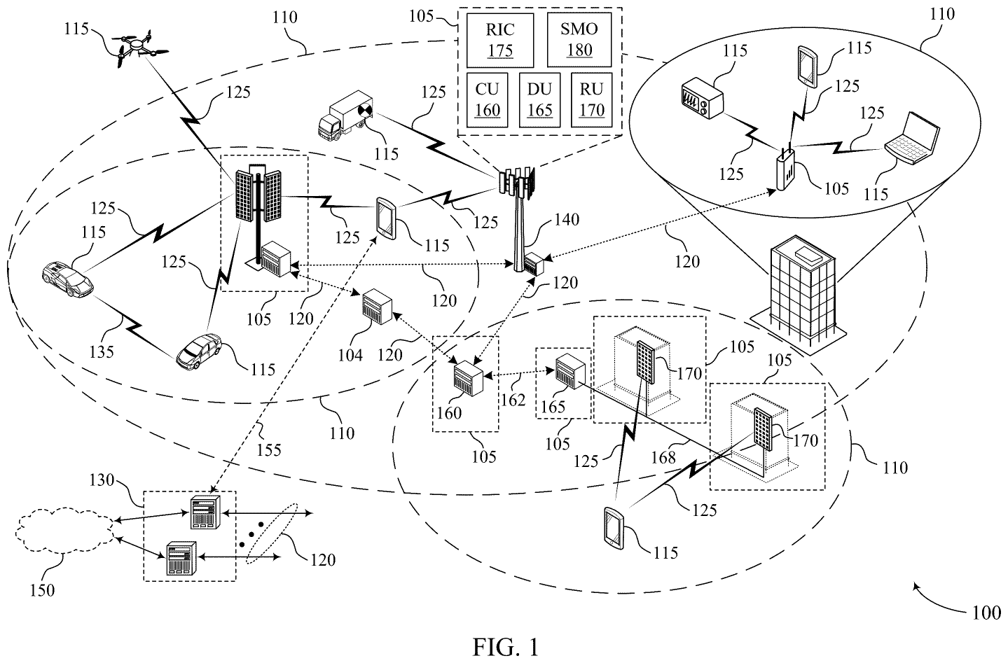

FIG. 1 shows an example of a wireless communications system 100 that supports wireless links for data center traffic in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

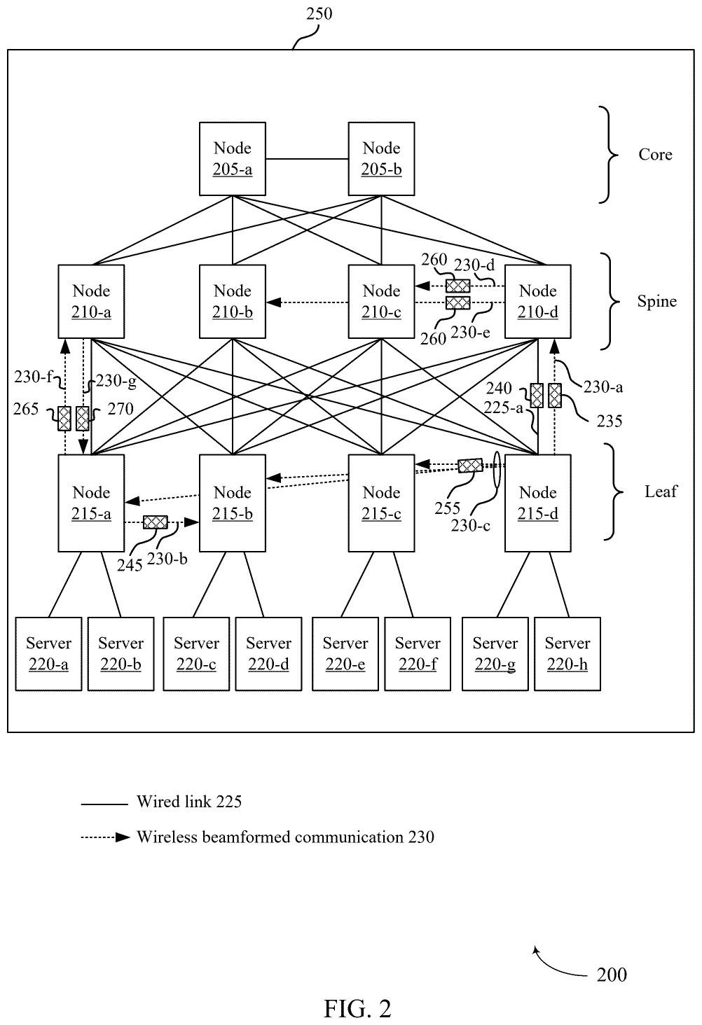

Data centers may be computing farms connected to the internet and used for a variety of applications such as hosting services (e.g., cloud storage or websites), responding to web queries (e.g., search engines), or social media. Data centers may be distributed in nature. For example, processing of a single Web query may engage hundreds of servers, and thus data center networking (DCN) may have a central role in data center architectures. DCN requirements may be driven by throughput and latency with demand for multiple peta bits per second (Pbps) bisection bandwidth and end-to-end latencies of tens of microseconds. Throughput demands for data centers may continue to grow (e.g., may double every 12-24 months). Data centers may include hundreds or thousands of servers (e.g., a data center may include over 100 thousand servers). Given the quantity of servers in a data center, full mesh wired networks for data centers may be impractical as connecting N server racks in a full mesh network involves N² wired links, which would involve thousands or millions of wired links when N>100 or N>1000. Accordingly, data centers may use a hierarchical structure with two or three levels (e.g., a leaf-spine-core topology) to create a wired path between each server rack with a reduced quantity of wired links. For example, multiple servers or server racks may be connected to a leaf switch node, which may be connected to other leaf switch nodes via spine switch nodes and/or core switch nodes. In such wired data center networks, each wired link connects two switch nodes, as shown with reference to FIG. 2.

Wireless communications between switch nodes may be implemented in a data center, for example, in addition to the wired link paths. For example, switch nodes may include wireless communication devices such as nodes of the wireless communications system 100 as described herein which may communicate with each other. As switch nodes within a data center may be stationary, beam training (e.g., as described herein) for wireless communication between the switch nodes may be performed infrequently (e.g., at a low periodicity or when new switch nodes are added to the data center). Wireless communications in data centers may use sub-THz or 60 GHz frequency bands, which may allow for high bandwidth and therefore large throughput approaching the data rate supported by wired connections. Sub-THz and 60 GHz communications allow for narrow beams, which allow for high spectrum spatial reuse (e.g., based on minimal interference between wireless communication between the different switch nodes).

FIG. 2 shows an example of a data center communications system 200 that supports wireless links for data center traffic in accordance with one or more aspects of the present disclosure. The data center communications system 200 may implement or may be implemented by aspects of the wireless communications system 100.

The data center 250 may include multiple servers 220. As described herein, wired links 225 may be used to support low latency and high throughput demands of the data center 250. The wired links 225 may be wired optical links to meet the latency and throughput demands of the data center 250. Given that data centers may include hundreds or thousands of servers 220, the data center 250 may use a hierarchical topology of wired links 225 between the servers 220.

For example, the servers 220 may be connected via multiple switch nodes in a leaf-spine topology. Accordingly, each leaf switch node 215 may be connected to one or more servers 220, and spine switch nodes 210 may interconnect the leaf switch nodes 215. For example, the leaf switch node 215-a may have a wired link 225 with each of the server 220-a and the server 220-b, and the leaf switch node 215-a may have a wired link 225 with each of the spine switch node 210-a, the spine switch node 210-b, the spine switch node 210-c, and the spine switch node 210-d. The leaf switch node 215-b may have a wired link 225 with each of the server 220-c and the server 220-d, and the leaf switch node 215-b may have a wired link 225 with each of the spine switch node 210-a, the spine switch node 210-b, the spine switch node 210-c, and the spine switch node 210-d. The leaf switch node 215-c may have a wired link 225 with each of the server 220-e and the server 220-f, and the leaf switch node 215-c may have a wired link 225 with each of the spine switch node 210-a, the spine switch node 210-b, the spine switch node 210-c, and the spine switch node 210-d. The leaf switch node 215-d may have a wired link 225 with each of the server 220-g and the server 220-h, and the leaf switch node 215-d may have a wired link 225 with each of the spine switch node 210-a, the spine switch node 210-b, the spine switch node 210-c, and the spine switch node 210-d. In some examples, a set of core switch nodes 205 may interconnect the spine switch nodes 210. For example, the core switch node 205-a may have a wired link 225 with each of the spine switch node 210-a, the spine switch node 210-b, the spine switch node 210-c, and the spine switch node 210-d. The core switch node 205-b may have a wired link 225 with each of the spine switch node 210-a, the spine switch node 210-b, the spine switch node 210-c, and the spine switch node 210-d. The core switch nodes 205 may be routers connected to the internet (e.g., to route data to and from the servers 220 for user applications).

As described herein, each optical fiber (e.g., each wired link 225) statically connects two switch nodes (e.g., a leaf switch node 215, a spine switch node 210, and/or a core switch node 205) regardless of the instantaneous throughput demand between the two switch nodes. Thus, to ensure high reliability and support peak throughputs, absent wireless communication capabilities, the link capacities of the wired links 225 may be over-provisioned. Such over-provisioning may lead to low average utilization of data center wired communication resources (e.g., as low as 30%). The hierarchical structure may also introduce multiple hops between the source and destination for a given communication, which may result in high latency. For example, a wired communication from the server 220-h to the server 220-f may involve three switch nodes (e.g., the leaf switch node 215-d, the spine switch node 210-d, and the leaf switch node 215-c) and two wired links 225 between the switch nodes. Additionally, or alternatively, multiple hops may involve multiple switch nodes participating in a given communication (e.g., packet transmission), thus burdening the data center communications system 200.

The data center 250 may support wireless connectivity to augment the wired links of the data center 250. For example, each switch node (e.g., the leaf switch nodes 215, the spine switch nodes 210, and the core switch nodes 205) may support wireless communication. For example, the switch nodes may include wireless communication devices such as a node of the wireless communications system 100 as described herein. In some examples, the data center 250 may support sub-THz and/or 60 GHz wireless links between the switch nodes. For example, sub-THz wireless links may operate in the 90-300 GHz range, and 60 GHz wireless links may operate in the 57 to 71 GHz range. Sub-THz and 60 GHz wireless links may have high throughput and may achieve wireless capacity similar to optical wired networks. For example, a sub-THz wireless link may operate using a 20 GHz bandwidth, which may support up to 400 gigabits per second (Gbps) for full duplex using two spatial layers (e.g., 5 bits/Hz*20 GHz*2 layers*2 (transmit and receive full duplex)=400 Gbps). A 60 GHz wireless link may operate using a 4 GHz bandwidth, which may support up to 56 Gbps for full duplex using two spatial layers (e.g., 3.5 bits/Hz*4 GHz*2 layers*2 (transmit and receive full duplex)=56 Gbps). The sub-THz and 60 GHz bands, characterized by high frequencies, correspond to small wavelengths. This property enables the use of multiple antenna elements or compact lenses. Multiple antenna elements or small lenses may allow for focused (e.g., narrow) beams for wireless links. Such focused beams enable flexible dynamic link establishment and termination based on instantaneous throughput demands. Further, the highly directional narrow beams and pathloss at the sub-THz and 60 GHz frequencies facilitate spatial reuse of the spectrum (e.g., enables low interference between the beams connecting different switch nodes). Further, dynamic null steering may be used to further reduce interference. Additionally, or alternatively, wireless links allow for broadcasting of communications to multiple switch nodes. For example, computational tasks involving packet distribution to multiple nodes may be achieved through a single broadcast or multicast wireless transmission (e.g., as compared to multiple transmissions to target switch nodes over several wired link paths).

To support wireless communication in the data center 250, the switch nodes may perform beam training (e.g., beam sweeping as described herein) to determine which wireless beam to use to transmit to other switch nodes in the data center 250. In some examples, the switch nodes may perform beam training periodically (e.g., once per minute, once per hour, once per day). In some examples, as the switch nodes may be stationary within the data center 250, the switch nodes may perform beam training when the architecture of the data center 250 is modified (e.g., a new switch node is added to the data center 250, a location of a switch node is changed within the data center 250, or a switch node is removed from the data center 250). Based on performance of beam training, a given switch node may identify which beam to use to wirelessly transmit a packet to any other particular switch node within the data center 250.

Based on support of wireless communications in the data center 250, the wired links 225 may be dimensioned for average throughput per wired link 225. Wireless communications within the data center 250 may be used to augment wired traffic. For example, when the volume of traffic on a particular wired link 225 between two switch nodes exceeds a threshold (e.g., based on the capacity of the wired link 225), a wireless link between the two switch nodes may be used to transmit at least some of the data (e.g., the portion of the data exceeding the threshold). As an example, the leaf switch node 215-d may have data to transmit to the spine switch node 210-d. Based on the conditions of the wired link 225-a between the leaf switch node 215-d and the spine switch node 210-d and the size of the data to transmit to the spine switch node 210-d, the leaf switch node 215-d may transmit at least at portion of the data to the spine switch node 210-d as a wireless beamformed communication 235 via the wireless link 230-a (e.g., using the beam determined for transmission to the spine switch node 210-d during beam training). In some examples, the leaf switch node 215-d may further transmit a second portion of the data as a wired communication 240 via the wired link 225-a. In some examples, the relative sizes of the wireless beamformed communication 235 and the wired communication 240 may depend on the volume of traffic on the wired link 225-a (e.g., in both directions) and the capacity of the wired link 225-a. In some examples, the threshold volume of traffic may depend on the quality of the wireless link between the source switch node and the target switch node (e.g., the wireless link capacity). For example, when the quality of the wireless link 230-a between the leaf switch node 215-d and the spine switch node 210-d is higher, the threshold volume of traffic may be lower (e.g., the leaf switch node 215-d may be more likely to use the wireless link 230-a and/or may transmit a higher percentage of traffic via the wireless link 230-a as compared with the wired link 225-a). In some examples, the threshold may be varying over time (e.g., due to the quality of the wireless link 230-a).

In some examples, the data center 250 may use wireless communications for transmission of packets with low latency demands. For example, the leaf switch node 215-a may transmit a wireless beamformed communication 245 directly to the leaf switch node 215-b via the wireless link 230-b based on a latency demand associated with the packet(s) in the wireless beamformed communication 245. For example, transmission via the wired link path between the leaf switch node 215-a and the leaf switch node 215-b may involve the wired link 225 between the leaf switch node 215-a and the spine switch node 210-a and the wired link 225 between the spine switch node 210-a and the leaf switch node 215-b. In some examples, a source switch node (e.g., a switch node with a packet to transmit) may determine whether to transmit a packet via a wireless link 230 or a wired link 225 based on the quantity of hops (e.g., wired links 225) in the wired link path between the source switch node and the target switch node and the latency demand of the packet. For example, the source switch node may determine to use the wired link path if the wired link path includes one wired link 225 (e.g., there is a direct wired link between the source and target switch nodes) and the source switch node may determine to use a wireless link 230 if the wired link path includes multiple wired links 225 (e.g., there is at least one intermediary switch node between the source and target switch nodes). As another example, the source switch node may determine to use the wired link path if the wired link path includes two or fewer wired links 225 (e.g., there is at most one intermediary switch node between the source and target switch nodes) and the source switch node may determine to use a wireless link 230 if the wired link path includes more than two wired links 225 (e.g., there is more than one intermediary switch node between the source and target switch nodes). In some examples, the source switch node may determine the threshold quantity of hops (e.g., intermediary switch nodes) along a wired link path before using a wireless link 230 based on the latency demand of a given packet.

In some examples, wireless links may be used for full duplex communications in the data center. For example, the leaf switch node 215-a may transmit a beamformed wireless data communication 265 to the spine switch node 210-a via the wireless link 230-f (e.g., via a first beam) that at least partially overlaps in time with reception of a beamformed wireless data communication 270 from the spine switch node 210-a via the wireless link 230-g (e.g., via a second beam). In some cases, for communication between two switch nodes, transmit and receive beams may be reciprocal. In some examples, a switch node may simultaneously wirelessly transmit to one switch node while receiving a wireless communication from a different switch node.

In some examples, wireless links may be used to broadcast or multicast a beamformed data communication. For example, during beam training, the switch nodes may identify point to multi-point beams to transmit to multiple other switch nodes via a single transmission. For example, the leaf switch node 215-d may transmit a single broadcast beamformed transmission 255 to the leaf switch node 215-a, the leaf switch node 215-b, and the leaf switch node 215-c using a wireless link 230-c (e.g., via a point to multi-point beam). In some examples, the data center 250 may support multicast communications. For example, the spine switch node 210-d may transmit a wireless beamformed communication 260 to the spine switch node 210-c via the wireless link 230-d between the spine switch node 210-d and the spine switch node 210-c (e.g., via a first beam) and to the spine switch node 210-b via the wireless link 230-e between the spine switch node 210-d and the spine switch node 210-b (e.g., via a second beam). Replacing multi-hop wired data transfer with single transmissions (e.g., broadcast or multicast) to multiple switch nodes may reduce latency and burden on the intermediary switch nodes of the data center 250.

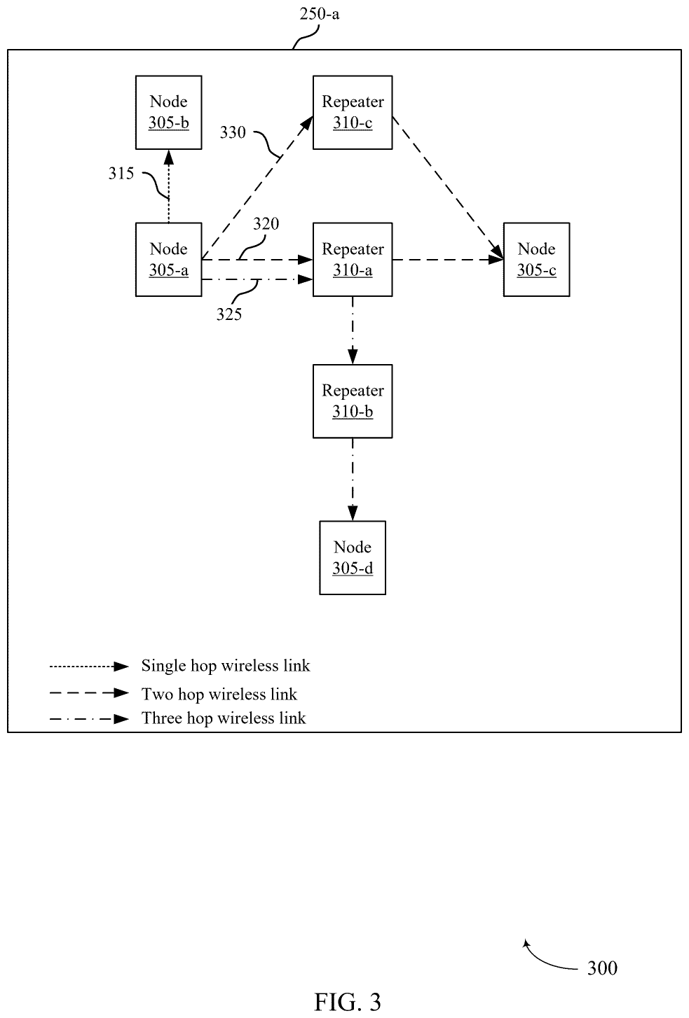

FIG. 3 shows an example of a data center communications system 300 that supports wireless links for data center traffic in accordance with one or more aspects of the present disclosure. The data center communications system 300 may implement or may be implemented by aspects of the wireless communications system 100 or the data center communications system 200. For example, the data center communications system 300 may include switch nodes 305, which may be examples of core switch nodes 205, spine switch nodes 210, or leaf switch nodes 215 as described herein. The switch nodes 305 may be included in a data center 250-a, which may be an example of a data center 250 as described herein.

The data center 250-a may include assistive nodes such as repeaters 310 (e.g., analog repeaters). For example, the repeaters 310 may be used to dispatch packets with low latency throughout the data center 250-a. For example, the repeaters may be analog repeaters to reduce latency associated with the repeaters to near zero. The repeaters 310 may be equipped with beamforming capabilities, allowing dynamic establishment and termination of multi-hop wireless links. For example, the repeaters may be included in the beam training procedures for the data center 250-a as described herein. Repeaters 310 may be used where there is no line of sight between a source switch node 305 and a target switch node 305. Thus, inclusion of repeaters 310 may allow for wireless communication between switch nodes across the data center 250-a, even in large data centers without line of sight between some switch nodes. For example, wireless link paths in the data center may be single hop links (e.g., no intermediary switch nodes 305 or repeaters 310), two hop links (e.g., one intermediary switch node 305 or repeater 310), three hop links (e.g., two intermediary switch nodes 305 or repeaters 310), or more than three-hop links.

For example, the wireless link path 315 between the switch node 305-a and the switch node 305-b may be line of sight and may be a single hop link. As another example, the wireless link path 320 between the switch node 305-a and the switch node 305-c may include the repeater 310-a and thus may be a two hop link. For example, during beam training, the switch node 305-a may determine that to transmit a packet to the switch node 305-c, the switch node 305-a should transmit a packet to the repeater 310-a, which may then transmit the received packet onto the switch node 305-c. As another example, the wireless link path 325 between the switch node 305-a and the switch node 305-d may include the repeater 310-a and the repeater 310-b and thus may be a three hop link. For example, during beam training, the switch node 305-a may determine that to transmit a packet to the switch node 305-d, the switch node 305-a should transmit a packet to the repeater 310-a, which may then transmit the received packet onto the repeater 310-b, which may then transmit the received packet onto the switch node 305-d.

In some examples, repeaters may be used for link aggregation. For example, links may be aggregated to increase the total throughput. For example, the switch node 305-a may transmit to the switch node 305-c via both the wireless link path 320 which includes the repeater 310-a and the wireless link path 330 which includes the repeater 310-c simultaneously.

In some examples, switch nodes 305 may act as wireless repeaters for communications between other switch nodes. In some examples, reflective surfaces (e.g., reflectors) may be used as assistive nodes instead of analog repeaters. In some examples, the data center 250-a may include both analog repeaters and reflectors.

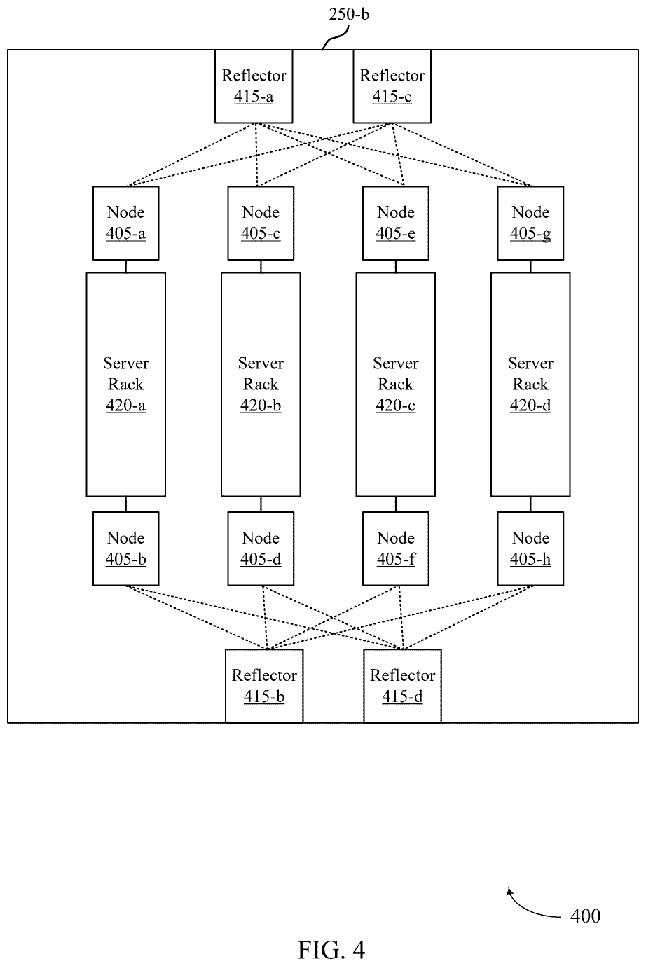

FIG. 4 shows an example of a data center communications system 400 that supports wireless links for data center traffic in accordance with one or more aspects of the present disclosure. The data center communications system 400 may implement or may be implemented by aspects of the wireless communications system 100, the data center communications system 200, or the data center communications system 300. For example, the data center communications system 400 may include server racks 420 (e.g., a server rack 420-a, a server rack 420-b, a server rack 420-c, and a server rack 420-d) which may each include one or more servers 220 as described herein. The server racks 420 may be included in a data center 250-b, which may be an example of a data center 250 as described herein. For example, the server racks 420 may each be rows of servers connected to a wireless node 405 at one or both ends of the server rack. As shown, in some examples, the server racks 420 may be connected to a wireless node 405 at each end of the server rack. For example, the wireless nodes 405 may be sub-THz or 60 GHz capable communications devices which the server racks 420 may use to communicate data to other server racks or a core switch node (e.g., to connect to the internet).

In some examples, the wireless node 405 may be a switch node 305 as described herein. In some examples, one wireless node 405 may not have a line of sight link with another wireless node 405, for example, due to intermediary server racks 420. For example, the wireless node 405-a may have a line of sight link with the wireless node 405-c but may not have a line of sight link with the wireless node 405-e or the wireless node 405-g. Similarly, the wireless node 405-c may have a line of sight link with the wireless node 405-e but may not have a line of sight link with the wireless node 405-g. As another example, the wireless node 405-b may have a line of sight link with the wireless node 405-d but may not have a line of sight link with the wireless node 405-f or the wireless node 405-h. As another example, the wireless node 405-d may have a line of sight link with the wireless node 405-f but may not have a line of sight link with the wireless node 405-h.

The data center 250-b may include assistive nodes, such as reflective surfaces 415 (e.g., reflectors) to assist in wireless beamforming between wireless nodes 405 when there is not a line of sight between the wireless nodes 405. For example, the reflective surfaces 415 may be placed on walls or ceilings of the data center 250-b. For example, the wireless node 405-a may communicate with the wireless node 405-e and/or the wireless node 405-g via the reflective surface 415-a or the reflective surface 415-c. Similarly, the wireless node 405-c may communicate with the wireless node 405-g via the reflective surface 415-a or the reflective surface 415-c. As another example, the wireless node 405-b may communicate with the wireless node 405-f and/or the wireless node 405-h via the reflective surface 415-b or the reflective surface 415-d. Similarly, the wireless node 405-d may communicate with the wireless node 405-h via the reflective surface 415-b or the reflective surface 415-d. The wireless nodes 405 may perform beam training using the reflective surfaces 415 such that the wireless nodes 405 may identify which beams to use to transmit to other given wireless nodes 405 (e.g., including via the reflective surfaces 415).

Improved communication between server racks 420 of the data center 250-b, such as via use of wireless communications involving assistive nodes may allow for more affordable, widely available, and low-latency communication. The data center 250-b may leverage such improved communication through tight multi-core processing. For example, energy-efficient accelerators may be placed in specific server racks 420. Such accelerators may be designed for particular computational tasks, and when such a specific computational job arises, the job may be routed from a general-purpose server or server rack 420 to the server or server rack 420 with the specialized accelerator, which may improve efficiency and reduce power consumption. As another example, memory and/or cache coherency across multiple cores may be achieved using the improved communication between server racks 420. For example, memory and/or cache coherency may be achieved via wireless broadcasting between the server racks 420 (e.g., via the wireless nodes 405 and reflective surfaces 415), enabling effective multi-rack or multi-server task processing. Such an approach may extend beyond the confines of a single multi-core server, and in such an approach, multiple server cores may collaborate via shared memory to enable a more distributed multi-server processing environment.

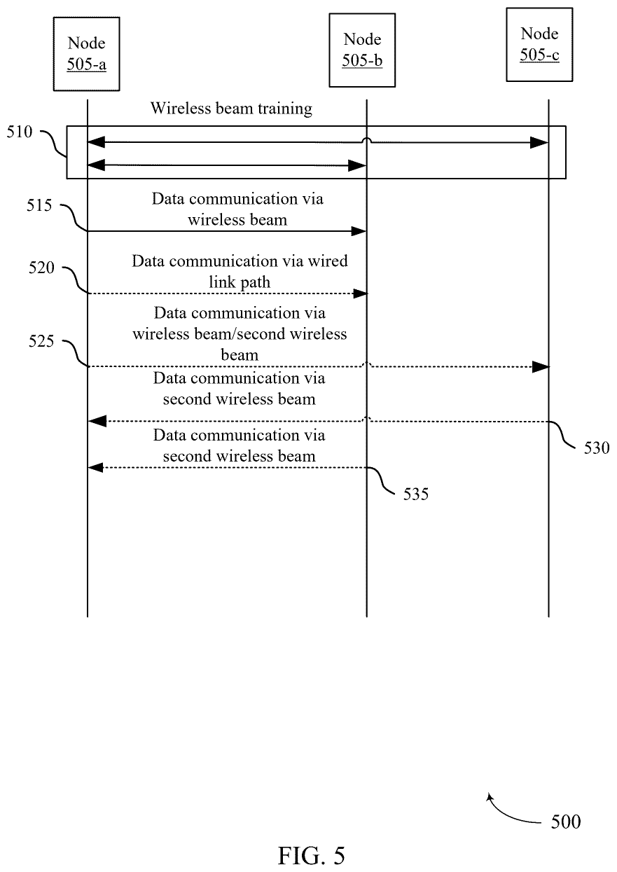

FIG. 5 shows an example of a process flow 500 that supports wireless links for data center traffic in accordance with one or more aspects of the present disclosure. The process flow 500 may include a switch node 505-a, a switch node 505-b, and a switch node 505-c, which may be examples of a leaf switch node 215, a spine switch node 210, a core switch node 205, a switch node 305, or a wireless node 405 as described herein. The switch node 505-a, the switch node 505-b, and the switch node 505-c may be included in a data center, which may be an example of a data center 250 as described herein. In the following description of the process flow 500, the operations between the switch node 505-a, the switch node 505-b, and the switch node 505-c may be transmitted in a different order than the example order shown, or the operations performed by the switch node 505-a, the switch node 505-b, and the switch node 505-c may be performed in different orders or at different times. Some operations may also be omitted from the process flow 500, and other operations may be added to the process flow 500.

At 510, the switch node 505-a may perform wireless beam training with one or more other switch nodes of the data center, including the switch node 505-b and the switch node 505-c. The switch node 505-a may be connected via one or more respective wired link paths to the one or more other switch nodes of the data center (e.g., via wired links 225 as described with reference to FIG. 2).

At 515, the switch node 505-a may transmit a data communication to the switch node 505-b via a wireless beam, where the wireless beam is based on the wireless beam training. Transmission of the data communication via the wireless beam may be based on a traffic condition at the switch node 505-a. In some examples, the data communication may be transmitted via one or both of a sub-THz frequency band or a 60 GHz frequency band.

In some examples, the traffic condition is a traffic volume exceeding a threshold associated with a wired link path between the switch node 505-a and the switch node 505-b, and the wired link path is one of the one or more respective wired link paths. In some examples, at 520, the switch node 505-a may transmit a second data communication to the switch node 505-b via the wired link path, where the second data communication at least partially overlaps in time with the data communication. For example, the wireless link between the switch node 505-a and the switch node 505-b may be used to supplement or augment communication over the wired link path between the switch node 505-a and the switch node 505-b based on traffic conditions involving the wired links of the wired link path between the switch node 505-a and the switch node 505-b. For example, the wired link path may include a set of multiple wired links and intermediary nodes (e.g., intermediary switch nodes), and the traffic volume exceeding the threshold may involve any one of the wired links of the set of multiple wired links having a traffic volume that exceeds a threshold for that wired link. In some examples, the threshold may depend on the quality of the wireless link between the switch node 505-a and the switch node 505-b (e.g., the wireless link capacity). For example, when the quality of the wireless link between the switch node 505-a and the switch node 505-b is higher, the threshold may be lower (e.g., the switch node 505-a may be more likely to use the wireless link). In some examples, the threshold may be varying over time (e.g., due to the quality of the wireless link).

In some examples, the traffic condition may be a latency requirement associated with the data communication. In some examples, the switch node 505-a may determine that a quantity of wired links in a wired link path between the switch node 505-a and the switch node 505-b exceeds a threshold quantity associated with the latency requirement (e.g., a quantity of intermediary switch nodes along the wired link path exceeds a threshold), and the traffic condition may be the quantity of wired links exceeding the threshold quantity.

In some examples, the traffic condition may be a type of data associated with the data communication, and the switch node 505-b may be associated with the type of data. For example, the switch node 505-b may be connected to a server rack which is specialized or designated for specific computing tasks, and the type of data associated with the data communication may be associated with the specific computing tasks.

In some examples, at 525, the traffic condition may be the broadcasting or multicasting of the data communication to multiple switch nodes (e.g., the switch node 505-b, the switch node 505-c, and/or other switch nodes 505 in the data center). For example, at 525, the switch node 505-a may transmit the data communication to the switch node 505-c via second wireless beam (e.g., the switch node may multicast the data communication), where transmission of the data communication to the switch node 505-c at least partially overlaps in time with transmission at 515 of the data communication to the switch node 505-b. As another example, at 525, the switch node 505-a may transmit the data communication to the switch node 505-c via the wireless beam (e.g., the switch node may broadcast the data communication via a point to multi-point beam, where the multiple recipients include at least the switch node 505-b and the switch node 505-c), where transmission of the data communication to the switch node 505-c at least partially overlaps in time with transmission at 515 of the data communication to the switch node 505-b. For example transmission of the data communication to the switch node 505-b and the switch node 505-c may be a single broadcast transmission using a same point to multi-point beam.

In some examples, at 515, the switch node 505-a may transmit the data communication at 515 to the switch node 505-b via an assistive node (e.g., a repeater or a reflective surface as described herein). In such examples, the wireless beam may be in a direction of the assistive node from a perspective of the switch node 505-a, and the wireless beam training may indicate for the switch node 505-a to use the assistive node for wireless communication with the switch node 505-b. In some examples, the switch node 505-a may transmit (e.g., with the transmission of the data communication) an indication that a destination of the data communication is the switch node 505-b, and the assistive node may route the data communication to the switch node 505-b based on the indicated destination.

In some examples, the switch node 505-a may support full duplex wireless communication. For example, at 530, the switch node 505-a may receive, from the switch node 505-c, a second data communication via a second wireless beam, where the second wireless beam is based on the wireless beam training, and where the second data communication at least partially overlaps in time with the data communication at 515. As another example, at 535, the switch node 505-a may receive, from the switch node 505-b, a second data communication via the wireless beam or a second wireless beam, where the wireless beam or the second wireless beam is based on the wireless beam training, and where the second data communication at least partially overlaps in time with the data communication at 515.

In some examples, the switch node 505-a may be connected via a set of wired connections to a set of servers. The switch node 505-a may receive data associated with the data communication from a server of the set of servers via the wired connection with the server, and transmission of the data communication at 515 may be based on reception of the data. For example, the switch node 505-a may route data from the set of servers to other servers in the data center or the internet via other switch nodes 505 of the data center.

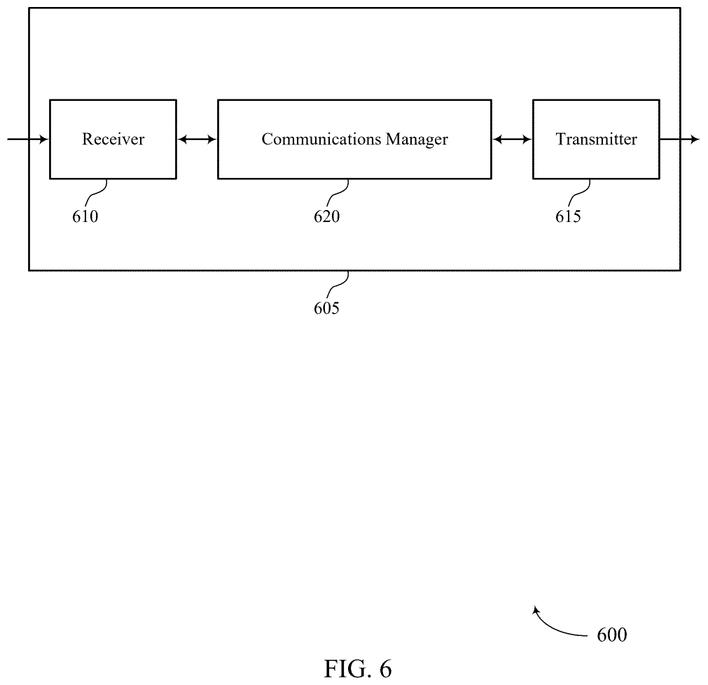

FIG. 6 shows a diagram 600 of a device 605 that supports wireless links for data center traffic in accordance with one or more aspects of the present disclosure. The device 605 may be an example of aspects of a UE 115, a switch node 305, a wireless node 405, or a switch node 505 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to wireless links for data center traffic). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to wireless links for data center traffic). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of wireless links for data center traffic as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for performing wireless beam training with one or more other network switch nodes of the data center, where the first network switch node is connected via one or more respective wired link paths to the one or more other network switch nodes. The communications manager 620 is capable of, configured to, or operable to support a means for transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources for devices in a data center.

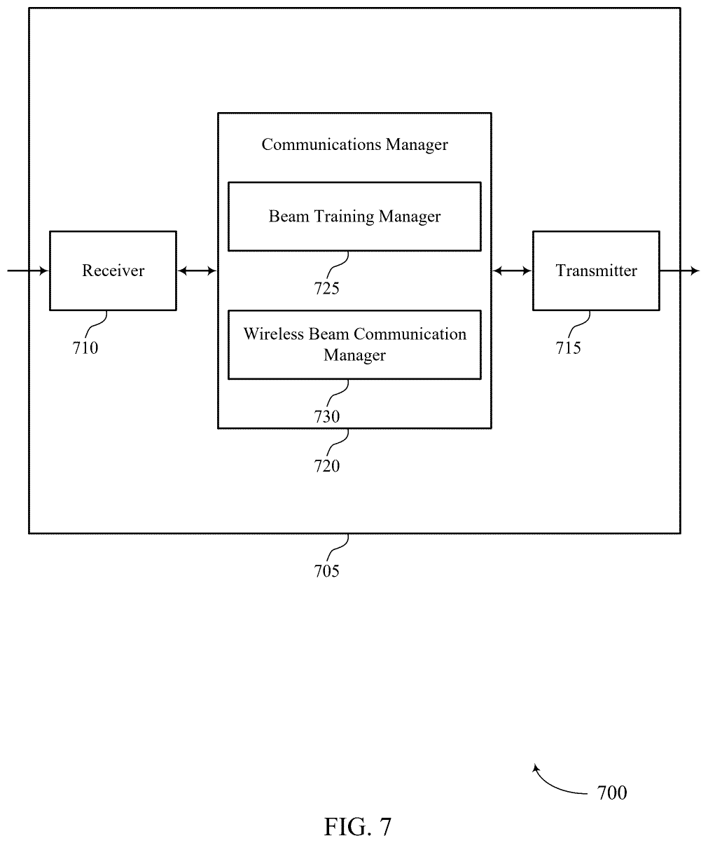

FIG. 7 shows a diagram 700 of a device 705 that supports wireless links for data center traffic in accordance with one or more aspects of the present disclosure. The device 705 may be an example of aspects of a device 605, a UE 115, a switch node 305, a wireless node 405, or a switch node 505 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to wireless links for data center traffic). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to wireless links for data center traffic). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of wireless links for data center traffic as described herein. For example, the communications manager 720 may include a beam training manager 725 a wireless beam communication manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The beam training manager 725 is capable of, configured to, or operable to support a means for performing wireless beam training with one or more other network switch nodes of the data center, where the first network switch node is connected via one or more respective wired link paths to the one or more other network switch nodes. The wireless beam communication manager 730 is capable of, configured to, or operable to support a means for transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

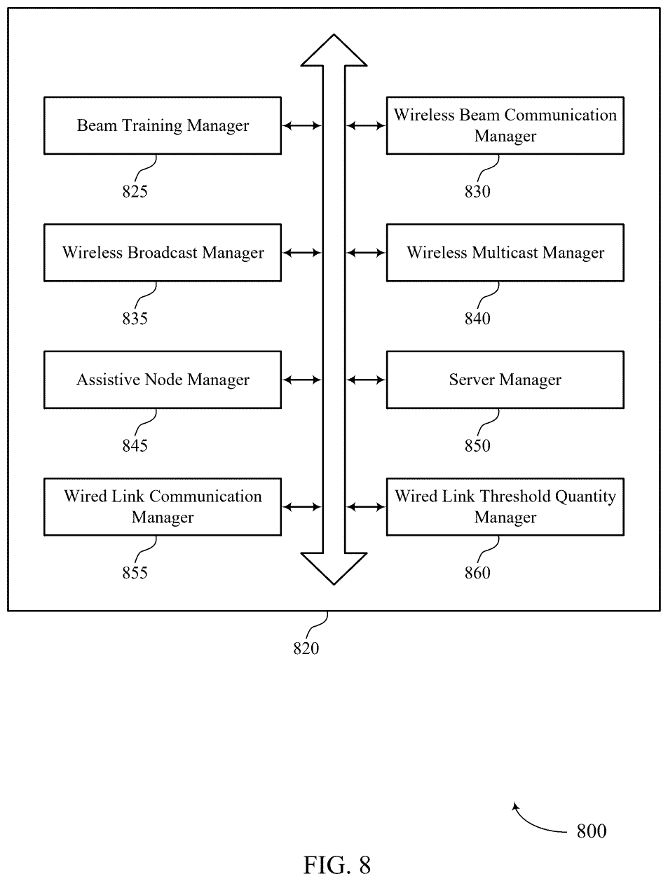

FIG. 8 shows a diagram 800 of a communications manager 820 that supports wireless links for data center traffic in accordance with one or more aspects of the present disclosure. The communications manager 820 may be an example of aspects of a communications manager 620, a communications manager 720, or both, as described herein. The communications manager 820, or various components thereof, may be an example of means for performing various aspects of wireless links for data center traffic as described herein. For example, the communications manager 820 may include a beam training manager 825, a wireless beam communication manager 830, a wireless broadcast manager 835, a wireless multicast manager 840, an assistive node manager 845, a server manager 850, a wired link communication manager 855, a wired link threshold quantity manager 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The beam training manager 825 is capable of, configured to, or operable to support a means for performing wireless beam training with one or more other network switch nodes of the data center, where the first network switch node is connected via one or more respective wired link paths to the one or more other network switch nodes. The wireless beam communication manager 830 is capable of, configured to, or operable to support a means for transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

In some examples, the traffic condition includes a traffic volume exceeding a threshold associated with a wired link path between the first network switch node and the second network switch node. In some examples, the wired link path is one of the one or more respective wired link paths.

In some examples, the wired link communication manager 855 is capable of, configured to, or operable to support a means for transmitting a second data communication to the second network switch node via the wired link path, where the second data communication at least partially overlaps in time with the data communication.

In some examples, the wired link path includes a set of multiple wired links. In some examples, the traffic volume exceeding the threshold associated with the wired link path includes the traffic volume exceeding the threshold for any wired link of the set of multiple wired links.

In some examples, the traffic condition includes a latency requirement associated with the data communication.

In some examples, the wired link threshold quantity manager 860 is capable of, configured to, or operable to support a means for determining that a quantity of wired links in a wired link path between the first network switch node and the second network switch node exceeds a threshold quantity associated with the latency requirement, where the traffic condition includes the quantity of wired links exceeding the threshold quantity, and where the wired link path is one of the one or more respective wired link paths.

In some examples, the traffic condition includes a type of data associated with the data communication. In some examples, the second network switch node is associated with the type of data.

In some examples, to support transmitting the data communication, the wireless broadcast manager 835 is capable of, configured to, or operable to support a means for transmitting the data communication to a third network switch node via the wireless beam, where the one or more other network switch nodes include the third network switch node, and where the traffic condition includes transmission of the data communication to the second network switch node and the third network switch node.

In some examples, the wireless multicast manager 840 is capable of, configured to, or operable to support a means for transmitting the data communication to a third network switch node via second wireless beam, where the one or more other network switch nodes include the third network switch node, where transmission of the data communication to the third network switch node at least partially overlaps in time with transmission of the data communication to the second network switch node, and where the traffic condition includes transmission of the data communication to the second network switch node and the third network switch node.

In some examples, to support transmitting the data communication, the assistive node manager 845 is capable of, configured to, or operable to support a means for transmitting the data communication to the second network switch node via an assistive node, where the wireless beam is in a direction of the assistive node from a perspective of the first network switch node, and where the wireless beam training indicates for the first network switch node to use the assistive node for wireless communication with the second network switch node.

In some examples, the assistive node manager 845 is capable of, configured to, or operable to support a means for transmitting, to the assistive node, an indication that a destination of the data communication is the second network switch node.

In some examples, to support transmitting the data communication, the wireless beam communication manager 830 is capable of, configured to, or operable to support a means for transmitting the data communication via one or both of a first bandwidth within a sub-THz frequency band or a second bandwidth of a 60 GHz frequency band.

In some examples, the wireless beam communication manager 830 is capable of, configured to, or operable to support a means for receiving, from the second network switch node, a second data communication via the wireless beam or a second wireless beam, where the wireless beam or the second wireless beam is based on the wireless beam training, and where the second data communication at least partially overlaps in time with the data communication.

In some examples, the wireless beam communication manager 830 is capable of, configured to, or operable to support a means for receiving, from third network switch node, a second data communication via a second wireless beam, where the second wireless beam is based on the wireless beam training, where the one or more other network switch nodes include the third network switch node, and where the second data communication at least partially overlaps in time with the data communication.

In some examples, the server manager 850 is capable of, configured to, or operable to support a means for receiving data associated with the data communication from a server via a wired connection between the server and the first network switch node, where the first network switch node is connected to a set of servers via a set of corresponding wired connections, the set of servers including the server, and where transmission of the data communication is based on reception of the data.

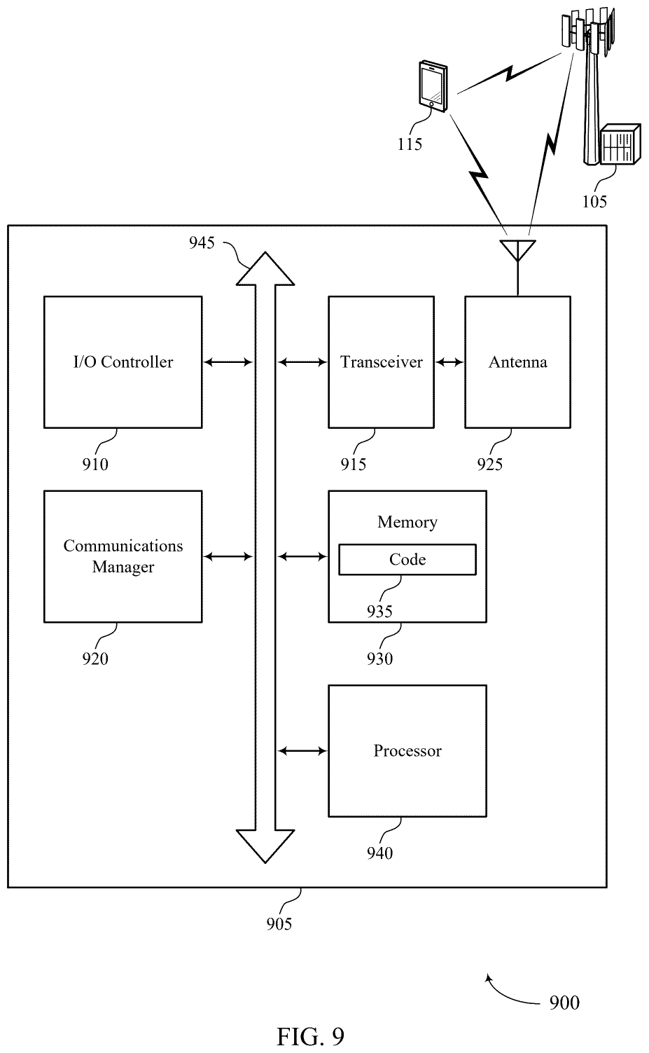

FIG. 9 shows a diagram of a system 900 including a device 905 that supports wireless links for data center traffic in accordance with one or more aspects of the present disclosure. The device 905 may be an example of or include components of a device 605, a device 705, a UE 115, a switch node 305, a wireless node 405, or a switch node 505 as described herein. The device 905 may communicate (e.g., wirelessly) with one or more other devices (e.g., switch nodes 305, wireless nodes 405, switch nodes 505, network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting wireless links for data center traffic). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for performing wireless beam training with one or more other network switch nodes of the data center, where the first network switch node is connected via one or more respective wired link paths to the one or more other network switch nodes. The communications manager 920 is capable of, configured to, or operable to support a means for transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node.

By including or configuring the communications manager 920 in accordance with examples as described herein, the device 905 may support techniques improved communication reliability, reduced latency, improved user experience related to reduced processing, reduced power consumption, more efficient utilization of communication resources, improved coordination between devices, and improved utilization of processing capability in a data center.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of wireless links for data center traffic as described herein, or the at least one processor 940 and the at least one memory 930 may be otherwise configured to, individually or collectively, perform or support such operations.

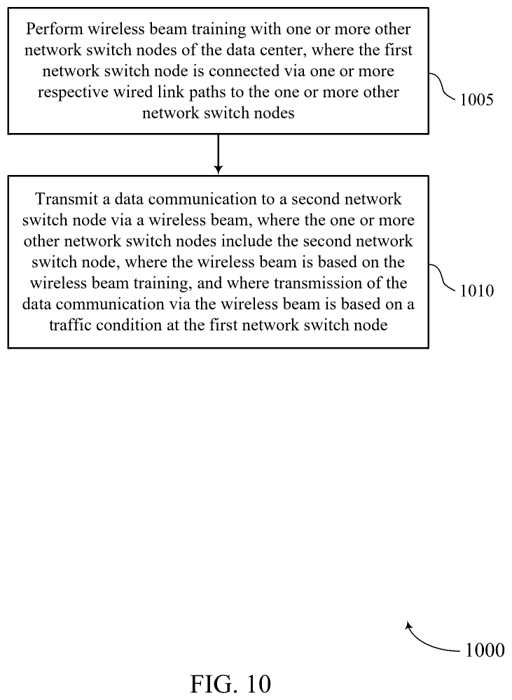

FIG. 10 shows a flowchart illustrating a method 1000 that supports wireless links for data center traffic in accordance with one or more aspects of the present disclosure. The operations of the method 1000 may be implemented by a node or its components as described herein. For example, the operations of the method 1000 may be performed by a node as described with reference to FIGS. 1 through 9. In some examples, a node may execute a set of instructions to control the functional elements of the node to perform the described functions. Additionally, or alternatively, the node may perform aspects of the described functions using special-purpose hardware.

At 1005, the method may include performing wireless beam training with one or more other network switch nodes of the data center, where the first network switch node is connected via one or more respective wired link paths to the one or more other network switch nodes. The operations of 1005 may be performed in accordance with examples as disclosed herein. In some examples, aspects of the operations of 1005 may be performed by a beam training manager 825 as described with reference to FIG. 8.

At 1010, the method may include transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node. The operations of 1010 may be performed in accordance with examples as disclosed herein. In some examples, aspects of the operations of 1010 may be performed by a wireless beam communication manager 830 as described with reference to FIG. 8.

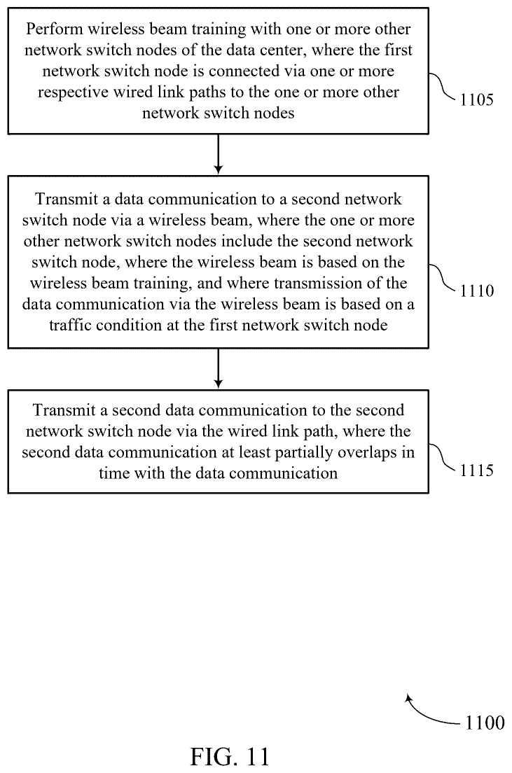

FIG. 11 shows a flowchart illustrating a method 1100 that supports wireless links for data center traffic in accordance with one or more aspects of the present disclosure. The operations of the method 1100 may be implemented by a node or its components as described herein. For example, the operations of the method 1100 may be performed by a node as described with reference to FIGS. 1 through 9. In some examples, a node may execute a set of instructions to control the functional elements of the node to perform the described functions. Additionally, or alternatively, the node may perform aspects of the described functions using special-purpose hardware.

At 1105, the method may include performing wireless beam training with one or more other network switch nodes of the data center, where the first network switch node is connected via one or more respective wired link paths to the one or more other network switch nodes. The operations of 1105 may be performed in accordance with examples as disclosed herein. In some examples, aspects of the operations of 1105 may be performed by a beam training manager 825 as described with reference to FIG. 8.

At 1110, the method may include transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node. The operations of 1110 may be performed in accordance with examples as disclosed herein. In some examples, aspects of the operations of 1110 may be performed by a wireless beam communication manager 830 as described with reference to FIG. 8.

At 1115, the method may include transmitting a second data communication to the second network switch node via the wired link path, where the second data communication at least partially overlaps in time with the data communication. The operations of 1115 may be performed in accordance with examples as disclosed herein. In some examples, aspects of the operations of 1115 may be performed by a wired link communication manager 855 as described with reference to FIG. 8.

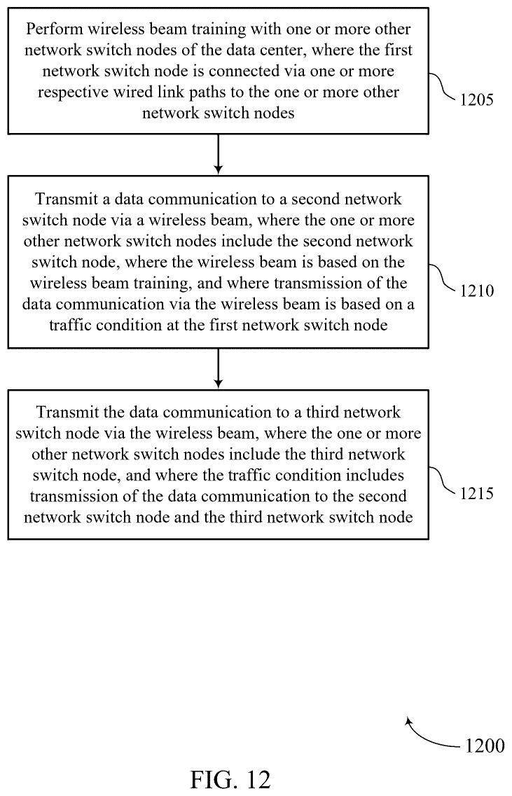

FIG. 12 shows a flowchart illustrating a method 1200 that supports wireless links for data center traffic in accordance with one or more aspects of the present disclosure. The operations of the method 1200 may be implemented by a node or its components as described herein. For example, the operations of the method 1200 may be performed by a node as described with reference to FIGS. 1 through 9. In some examples, a node may execute a set of instructions to control the functional elements of the node to perform the described functions. Additionally, or alternatively, the node may perform aspects of the described functions using special-purpose hardware.

At 1205, the method may include performing wireless beam training with one or more other network switch nodes of the data center, where the first network switch node is connected via one or more respective wired link paths to the one or more other network switch nodes. The operations of 1205 may be performed in accordance with examples as disclosed herein. In some examples, aspects of the operations of 1205 may be performed by a beam training manager 825 as described with reference to FIG. 8.

At 1210, the method may include transmitting a data communication to a second network switch node via a wireless beam, where the one or more other network switch nodes include the second network switch node, where the wireless beam is based on the wireless beam training, and where transmission of the data communication via the wireless beam is based on a traffic condition at the first network switch node. The operations of 1210 may be performed in accordance with examples as disclosed herein. In some examples, aspects of the operations of 1210 may be performed by a wireless beam communication manager 830 as described with reference to FIG. 8.

At 1215, the method may include transmitting the data communication to a third network switch node via the wireless beam, where the one or more other network switch nodes include the third network switch node, and where the traffic condition includes transmission of the data communication to the second network switch node and the third network switch node. The operations of 1215 may be performed in accordance with examples as disclosed herein. In some examples, aspects of the operations of 1215 may be performed by a wireless broadcast manager 835 as described with reference to FIG. 8.

The following provides an overview of aspects of the present disclosure:

Aspect 1: A method for wireless communications at a first network switch node of a data center, comprising: performing wireless beam training with one or more other network switch nodes of the data center, wherein the first network switch node is connected via one or more respective wired link paths to the one or more other network switch nodes; and transmitting a data communication to a second network switch node via a wireless beam, wherein the one or more other network switch nodes comprise the second network switch node, wherein the wireless beam is based at least in part on the wireless beam training, and wherein transmission of the data communication via the wireless beam is based at least in part on a traffic condition at the first network switch node.

Aspect 2: The method of aspect 1, wherein the traffic condition comprises a traffic volume exceeding a threshold associated with a wired link path between the first network switch node and the second network switch node, and the wired link path is one of the one or more respective wired link paths.

Aspect 3: The method of aspect 2, further comprising: transmitting a second data communication to the second network switch node via the wired link path, wherein the second data communication at least partially overlaps in time with the data communication.

Aspect 4: The method of any of aspects 2 through 3, wherein the wired link path comprises a plurality of wired links, and the traffic volume exceeding the threshold associated with the wired link path comprises the traffic volume exceeding the threshold for any wired link of the plurality of wired links.

Aspect 5: The method of any of aspects 1 through 4, wherein the traffic condition comprises a latency requirement associated with the data communication.

Aspect 6: The method of aspect 5, further comprising: determining that a quantity of wired links in a wired link path between the first network switch node and the second network switch node exceeds a threshold quantity associated with the latency requirement, wherein the traffic condition comprises the quantity of wired links exceeding the threshold quantity, and wherein the wired link path is one of the one or more respective wired link paths.

Aspect 7: The method of any of aspects 1 through 6, wherein the traffic condition comprises a type of data associated with the data communication, and the second network switch node is associated with the type of data.

Aspect 8: The method of any of aspects 1 through 7, wherein transmitting the data communication comprises: transmitting the data communication to a third network switch node via the wireless beam, wherein the one or more other network switch nodes comprise the third network switch node, and wherein the traffic condition comprises transmission of the data communication to the second network switch node and the third network switch node.

Aspect 9: The method of any of aspects 1 through 8, further comprising: transmitting the data communication to a third network switch node via second wireless beam, wherein the one or more other network switch nodes comprise the third network switch node, wherein transmission of the data communication to the third network switch node at least partially overlaps in time with transmission of the data communication to the second network switch node, and wherein the traffic condition comprises transmission of the data communication to the second network switch node and the third network switch node.

Aspect 10: The method of any of aspects 1 through 9, wherein transmitting the data communication comprises: transmitting the data communication to the second network switch node via an assistive node, wherein the wireless beam is in a direction of the assistive node from a perspective of the first network switch node, and wherein the wireless beam training indicates for the first network switch node to use the assistive node for wireless communication with the second network switch node.

Aspect 11: The method of aspect 10, further comprising: transmitting, to the assistive node, an indication that a destination of the data communication is the second network switch node.

Aspect 12: The method of any of aspects 1 through 11, wherein transmitting the data communication comprises: transmitting the data communication via one or both of a first bandwidth within a sub-THz frequency band or a second bandwidth of a 60 GHz frequency band.

Aspect 13: The method of any of aspects 1 through 12, further comprising: receiving, from the second network switch node, a second data communication via the wireless beam or a second wireless beam, wherein the wireless beam or the second wireless beam is based at least in part on the wireless beam training, and wherein the second data communication at least partially overlaps in time with the data communication.

Aspect 14: The method of any of aspects 1 through 13, further comprising: receiving, from third network switch node, a second data communication via a second wireless beam, wherein the second wireless beam is based at least in part on the wireless beam training, wherein the one or more other network switch nodes comprise the third network switch node, and wherein the second data communication at least partially overlaps in time with the data communication.

Aspect 15: The method of any of aspects 1 through 14, further comprising: receiving data associated with the data communication from a server via a wired connection between the server and the first network switch node, wherein the first network switch node is connected to a set of servers via a set of corresponding wired connections, the set of servers comprising the server, and wherein transmission of the data communication is based at least in part on reception of the data.

Aspect 16: A first network switch node of a data center, comprising one or more memories storing processor-executable code, and one or more processors coupled with the one or more memories and individually or collectively operable to execute the code to cause the first network switch node of a data center to perform a method of any of aspects 1 through 15.

Aspect 17: A first network switch node of a data center, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network switch node of a data center, comprising:
one or more memories storing processor-executable code; and
one or more processors coupled with the one or more memories and individually or collectively operable to execute the code to cause the first network switch node to:
perform wireless beam training with one or more other network switch nodes of the data center, wherein the first network switch node is connected via one or more respective wired link paths to the one or more other network switch nodes; and
transmit a data communication to a second network switch node via a wireless beam, wherein the one or more other network switch nodes comprise the second network switch node, wherein the wireless beam is based at least in part on the wireless beam training, and wherein transmission of the data communication via the wireless beam is based at least in part on a traffic condition at the first network switch node.

2. The first network switch node of claim 1, wherein:
the traffic condition comprises a traffic volume exceeding a threshold associated with a wired link path between the first network switch node and the second network switch node, and
the wired link path is one of the one or more respective wired link paths.

3. The first network switch node of claim 2, wherein the one or more processors are individually or collectively further operable to execute the code to cause the first network switch node to:
transmit a second data communication to the second network switch node via the wired link path, wherein the second data communication at least partially overlaps in time with the data communication.

4. The first network switch node of claim 2, wherein:
the wired link path comprises a plurality of wired links, and
the traffic volume exceeding the threshold associated with the wired link path comprises the traffic volume exceeding the threshold for any wired link of the plurality of wired links.

5. The first network switch node of claim 1, wherein the traffic condition comprises a latency requirement associated with the data communication.

6. The first network switch node of claim 5, wherein the one or more processors are individually or collectively further operable to execute the code to cause the first network switch node to:
determine that a quantity of wired links in a wired link path between the first network switch node and the second network switch node exceeds a threshold quantity associated with the latency requirement, wherein the traffic condition comprises the quantity of wired links exceeding the threshold quantity, and wherein the wired link path is one of the one or more respective wired link paths.

7. The first network switch node of claim 1, wherein:
the traffic condition comprises a type of data associated with the data communication, and
the second network switch node is associated with the type of data.

8. The first network switch node of claim 1, wherein, to transmit the data communication, the one or more processors are individually or collectively operable to execute the code to cause the first network switch node to:
transmit the data communication to a third network switch node via the wireless beam, wherein the one or more other network switch nodes comprise the third network switch node, and wherein the traffic condition comprises transmission of the data communication to the second network switch node and the third network switch node.

9. The first network switch node of claim 1, wherein the one or more processors are individually or collectively further operable to execute the code to cause the first network switch node to:
transmit the data communication to a third network switch node via second wireless beam, wherein the one or more other network switch nodes comprise the third network switch node, wherein transmission of the data communication to the third network switch node at least partially overlaps in time with transmission of the data communication to the second network switch node, and wherein the traffic condition comprises transmission of the data communication to the second network switch node and the third network switch node.

10. The first network switch node of claim 1, wherein, to transmit the data communication, the one or more processors are individually or collectively operable to execute the code to cause the first network switch node to:
transmit the data communication to the second network switch node via an assistive node, wherein the wireless beam is in a direction of the assistive node from a perspective of the first network switch node, and wherein the wireless beam training indicates for the first network switch node to use the assistive node for wireless communication with the second network switch node.

11. The first network switch node of claim 10, wherein the one or more processors are individually or collectively further operable to execute the code to cause the first network switch node to:
transmit, to the assistive node, an indication that a destination of the data communication is the second network switch node.

12. The first network switch node of claim 1, wherein, to transmit the data communication, the one or more processors are individually or collectively operable to execute the code to cause the first network switch node to:
transmit the data communication via one or both of a first bandwidth within a sub-terahertz frequency band or a second bandwidth of a 60 gigahertz frequency band.

13. The first network switch node of claim 1, wherein the one or more processors are individually or collectively further operable to execute the code to cause the first network switch node to:
receive, from the second network switch node, a second data communication via the wireless beam or a second wireless beam, wherein the wireless beam or the second wireless beam is based at least in part on the wireless beam training, and wherein the second data communication at least partially overlaps in time with the data communication.

14. The first network switch node of claim 1, wherein the one or more processors are individually or collectively further operable to execute the code to cause the first network switch node to:
receive, from third network switch node, a second data communication via a second wireless beam, wherein the second wireless beam is based at least in part on the wireless beam training, wherein the one or more other network switch nodes comprise the third network switch node, and wherein the second data communication at least partially overlaps in time with the data communication.

15. The first network switch node of claim 1, wherein the one or more processors are individually or collectively further operable to execute the code to cause the first network switch node to:
receive data associated with the data communication from a server via a wired connection between the server and the first network switch node, wherein the first network switch node is connected to a set of servers via a set of corresponding wired connections, the set of servers comprising the server, and wherein transmission of the data communication is based at least in part on reception of the data.

16. A method for wireless communications at a first network switch node of a data center, comprising:
performing wireless beam training with one or more other network switch nodes of the data center, wherein the first network switch node is connected via one or more respective wired link paths to the one or more other network switch nodes; and
transmitting a data communication to a second network switch node via a wireless beam, wherein the one or more other network switch nodes comprise the second network switch node, wherein the wireless beam is based at least in part on the wireless beam training, and wherein transmission of the data communication via the wireless beam is based at least in part on a traffic condition at the first network switch node.

17. The method of claim 16, wherein:
the traffic condition comprises a traffic volume exceeding a threshold associated with a wired link path between the first network switch node and the second network switch node, and
the wired link path is one of the one or more respective wired link paths.

18. The method of claim 17, further comprising:
transmitting a second data communication to the second network switch node via the wired link path, wherein the second data communication at least partially overlaps in time with the data communication.

19. The method of claim 17, wherein:
the wired link path comprises a plurality of wired links, and
the traffic volume exceeding the threshold associated with the wired link path comprises the traffic volume exceeding the threshold for any wired link of the plurality of wired links.

20. A non-transitory computer-readable medium storing code for wireless communications by a first network switch node of a data center, the code comprising instructions executable by one or more processors to:
perform wireless beam training with one or more other network switch nodes of the data center, wherein the first network switch node is connected via one or more respective wired link paths to the one or more other network switch nodes; and
transmit a data communication to a second network switch node via a wireless beam, wherein the one or more other network switch nodes comprise the second network switch node, wherein the wireless beam is based at least in part on the wireless beam training, and wherein transmission of the data communication via the wireless beam is based at least in part on a traffic condition at the first network switch node.
